(19) United States
(12) Patent Application Publication
(10) Pub. No.: US 2025/0035928 A1
(43) Pub. Date: Jan. 30, 2025

(54) APPARATUS, SYSTEM, AND METHOD FOR SPREADING LIGHT DIRECTED TOWARD DISPLAYS IN EYEWEAR DEVICES

(71) Applicant: Meta Platforms Technologies, LLC, Menlo Park, CA (US)

(72) Inventors: Wai Sze Tiffany Lam, Lynnwood, WA (US); Wanli Chi, Sammamish, WA (US); Marvin Dion Alim, Duvall, WA (US); Alexander Sohn, Seattle, WA (US); Jacques Gollier, Sammamish, WA (US)

(21) Appl. No.: 18/677,206

(22) Filed: May 29, 2024

Related U.S. Application Data
(60) Provisional application No. 63/515,579, filed on Jul. 25, 2023.

(51) Int. Cl. G02B 27/01; G02B 5/30

(52) U.S. Cl. CPC G02B 27/0172; G02B 5/3025; G02B 2027/0178

(57) ABSTRACT

A system comprising (1) an eyewear device dimensioned to be worn by a user and (2) a compact beam expander incorporated in the eyewear device, the compact beam expander comprising (A) a first light-spreading element configured to diffract light received from a light source, (B) a second light-spreading element configured to further diffract the light, and (C) a pixel element that is positioned proximate to the second light-spreading element and configured to direct the light toward a lens that focuses the light for an eye of the user. Various other apparatuses, systems, and methods are also disclosed.

### CROSS REFERENCE TO RELATED APPLICATION

This application claims the benefit of U.S. Provisional Application No. 63/515,579 filed Jul. 25, 2023, the disclosure of which is incorporated in its entirety by this reference.

### BRIEF DESCRIPTION OF DRAWINGS

The accompanying Drawings illustrate a number of exemplary embodiments and are parts of the specification. Together with the following description, the Drawings demonstrate and explain various principles of the instant disclosure.

FIG. 1 is an illustration of an exemplary apparatus for spreading light directed toward displays in eyewear devices according to one or more embodiments of this disclosure.

FIG. 2 is an illustration of an exemplary system for spreading light directed toward displays in eyewear devices according to one or more embodiments of this disclosure.

FIG. 3 is an illustration of an exemplary eyewear device equipped with a compact beam expander capable of spreading light for a display according to one or more embodiments of this disclosure.

FIG. 4 is an illustration of an exemplary apparatus for spreading light directed toward displays in eyewear devices according to one or more embodiments of this disclosure.

FIG. 5 is an illustration of an exemplary implementation of a compact beam expander configured to spread light for a display according to one or more embodiments of this disclosure.

FIG. 6 is an illustration of an exemplary system for spreading light directed toward displays in eyewear devices according to one or more embodiments of this disclosure.

FIG. 7 is an illustration of an exemplary compact beam expander for spreading light directed toward displays in eyewear devices according to one or more embodiments of this disclosure.

FIG. 8 is an illustration of an exemplary implementation of a compact beam expander configured to spread light for a display according to one or more embodiments of this disclosure.

FIG. 9 is an illustration of an exemplary implementation of a compact beam expander configured to spread light for a display according to one or more embodiments of this disclosure.

FIG. 10 is an illustration of an exemplary implementation of a compact beam expander configured to spread light for a display according to one or more embodiments of this disclosure.

FIG. 11 is an illustration of an exemplary implementation of a compact beam expander configured to spread light for a display according to one or more embodiments of this disclosure.

FIG. 12 is a flowchart of an exemplary method for integrating antennas that support multiple wireless technologies into artificial-reality devices according to one or more embodiments of this disclosure.

FIG. 13 is an illustration of exemplary AR system that may be used in connection with embodiments of this disclosure.

FIG. 14 is an illustration of an exemplary VR system that may be used in connection with embodiments of this disclosure.

While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION

The present disclosure is generally directed to apparatuses, systems, and methods for spreading light directed toward displays in eyewear devices. For example, an eyewear device may implement and/or incorporate a display system equipped with light-spreading elements for use in artificial-reality applications. In one example, the eyewear device may implement and/or incorporate efficient, compact beam expanders that spread light beams from pixelated displays, such as liquid crystal on silicon (LCoS) displays, to improve display image quality. As will be explained in greater detail below, these apparatuses, systems, and methods may provide numerous features and benefits.

In some examples, two-dimensional displays may be illuminated in the back end by coherent, collimated light sources (e.g., lasers) that cover the entire area viewable by users. Such designs may impose certain constraints that limit the workable size of the two-dimensional displays. Additionally or alternatively, multilayered displays for virtual reality and/or augmented reality (VR/AR) applications may have low transmission efficiency that negatively impacts and/or exacerbates power consumption to the detriment of battery lifetime. In certain implementations, battery lifetime may be an important design consideration for VR/AR eyewear devices.

In some examples, given their ability to illuminate with high intensity light-emitting diodes (LEDs) and their low power operation, LCOS displays may be a suitable choice for use in augmented reality (AR) eyewear devices. Unfortunately, form factors for conventional LCoS-based display engines may be too large and/or heavy for users to wear comfortably in AR eyewear devices. As a result, such LCoS-based display engines may be unsuitable for use in many AR eyewear devices.

In some examples, the volume and/or mass of display engines may grow commensurate with field of view (FOV), so addressing FOVs for wide-FOV AR devices may become unworkable and/or untenable. Additionally or alternatively, the corresponding component count may be very high, even requiring multiple alignment and/or bonding steps as well as a complex, high precision, stable housing. As such, the costs for conventional LCoS-based display engines may be significant and/or excessive. Accordingly, it may be desirable to shrink and/or decrease the form factor of LCOS-based display engines, while also maintaining and/or improving angular uniformity and spread.

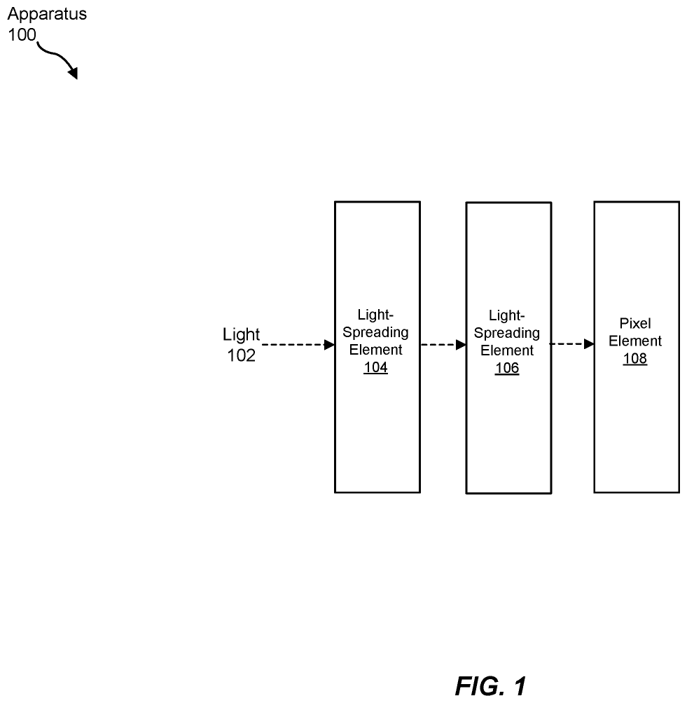

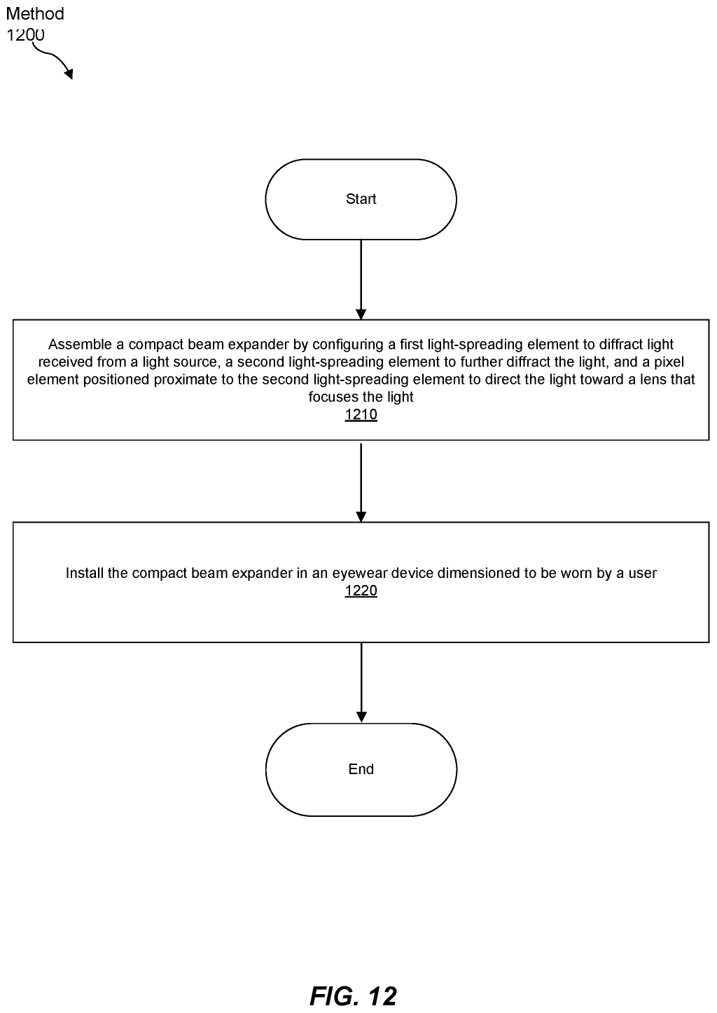

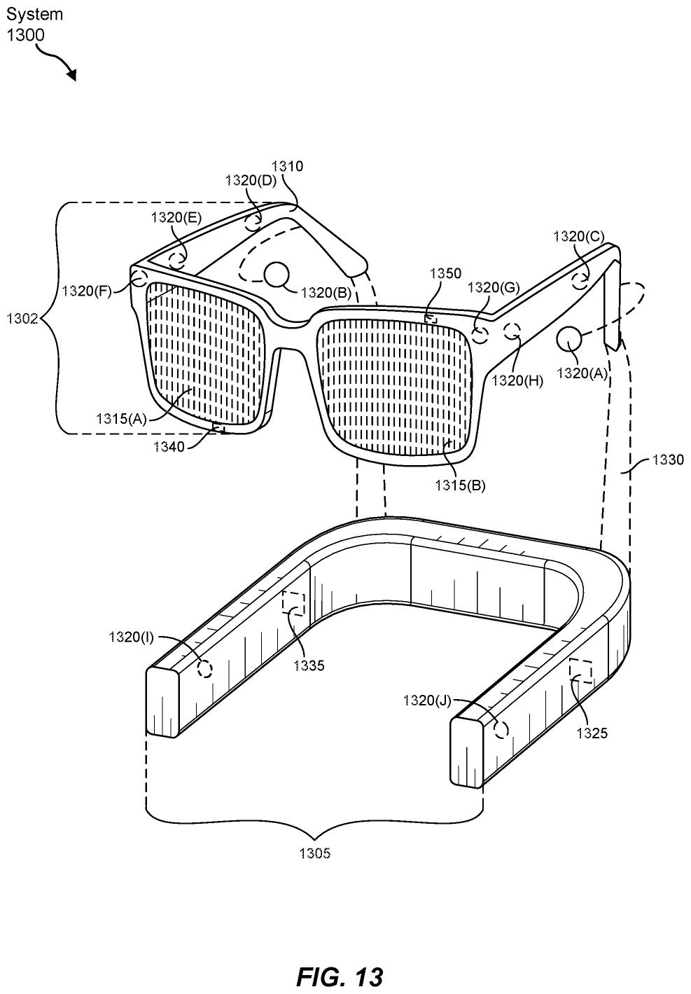

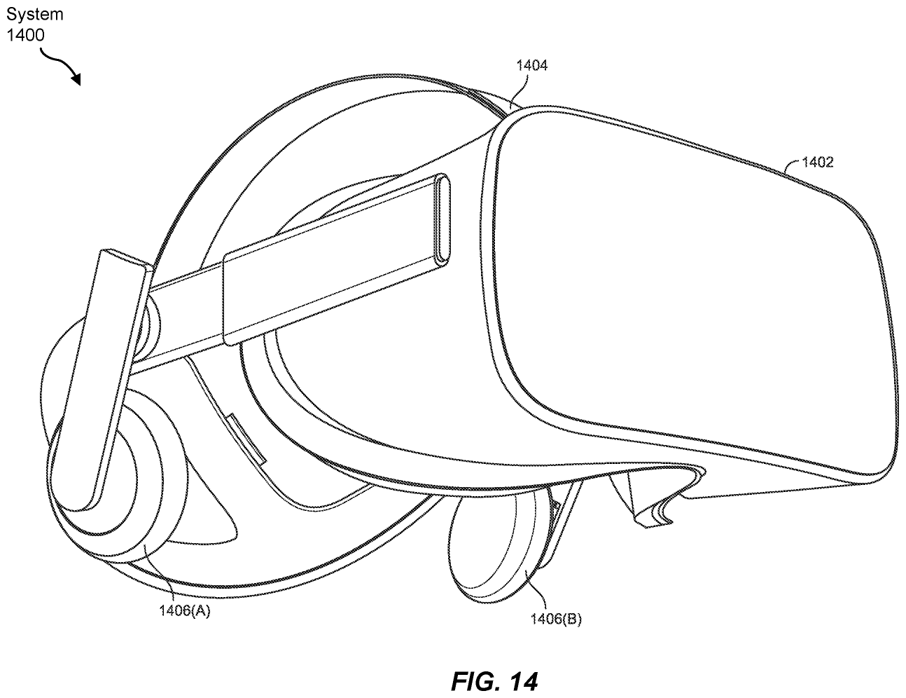

The following will provide, with reference to FIGS. 1-11, detailed descriptions of exemplary apparatuses, devices, systems, components, and corresponding configurations for spreading light directed toward displays in eyewear devices. In addition, detailed descriptions of methods for spreading light directed toward displays in eyewear devices in connection with FIG. 12. The discussion corresponding to FIGS. 13-14 will provide detailed descriptions of types of exemplary artificial-reality devices, wearables, and/or associated systems capable of spreading light directed toward displays in eyewear devices.

FIG. 1 illustrates an exemplary apparatus 100 capable of spreading and/or expanding light directed toward displays in eyewear devices. As illustrated in FIG. 1, apparatus 100 may include and/or represent a light-spreading element 104, a light-spreading element 106, and/or a pixel element 108. In some examples, apparatus 100 may constitute and/or be implemented as a compact beam expander incorporated in an eyewear device (such as a VR/AR headset and/or a LCoS display system) dimensioned to be worn by a user.

In some examples, light-spreading element 104 may receive and/or obtain light 102 from a light source (e.g., a laser and/or collimated light source). In one example, light-spreading element 104 may diffract, refract, and/or spread light 102 toward light-spreading element 106. In this example, light-spreading element 106 may also diffract, refract, and/or spread light 102 toward pixel element 108. In certain implementations, pixel element 108 may direct, pass, and/or transmit light 102 toward a lens (e.g., a projection lens and/or an imaging lens) that focuses, presents, and/or displays light 102 for an eye of the user.

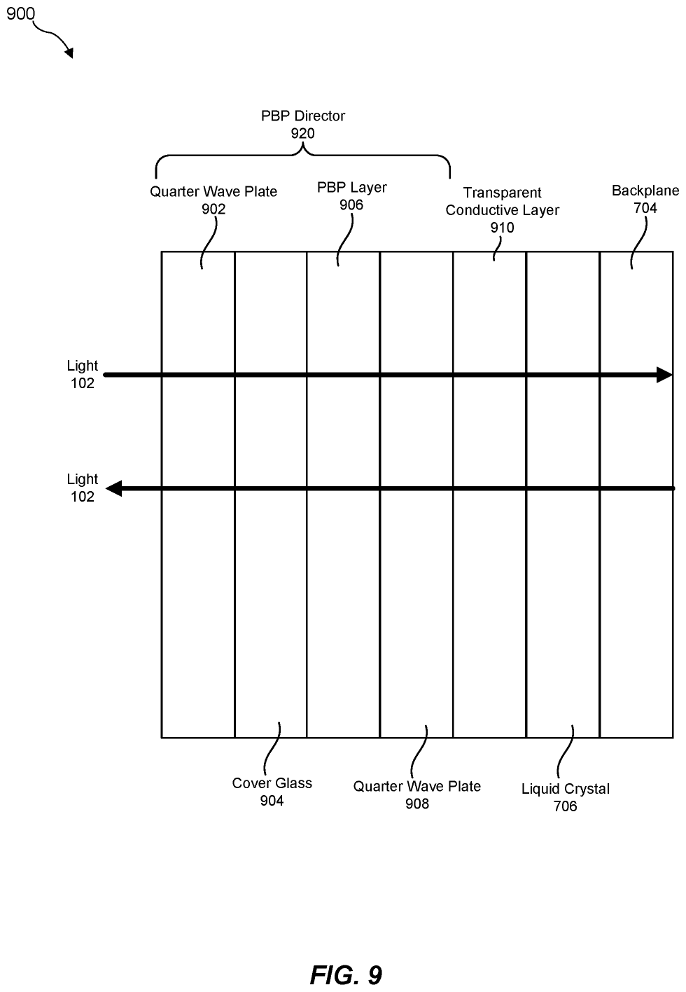

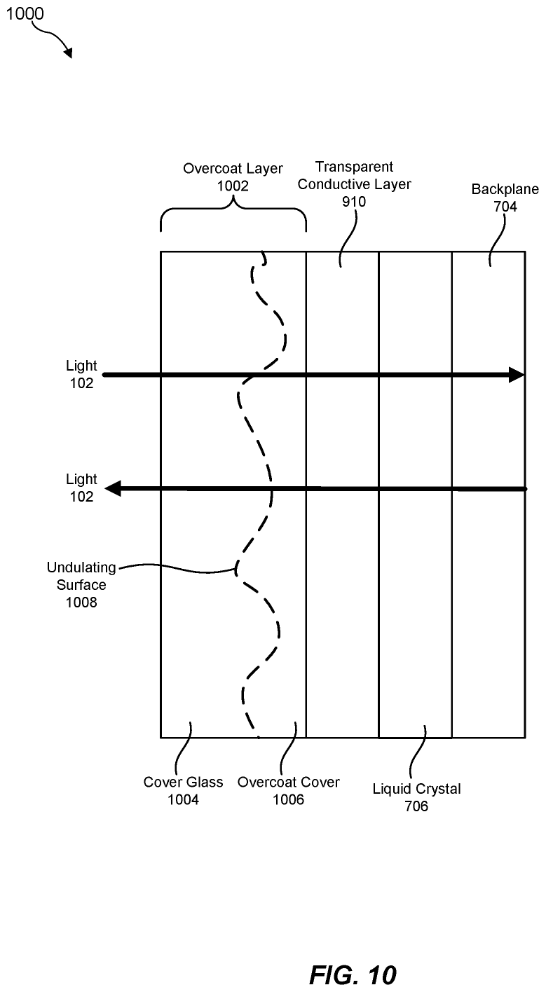

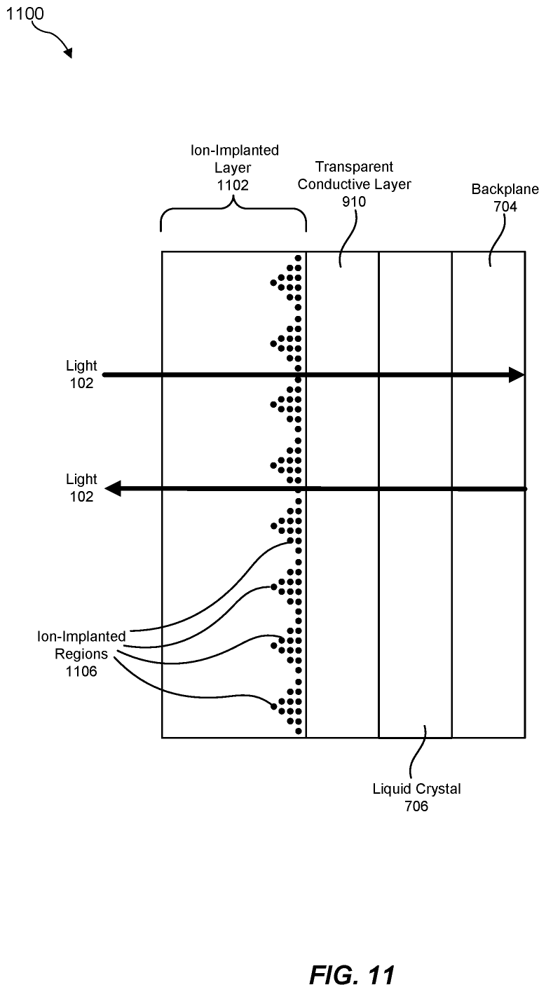

In some examples, light-spreading elements 104 and 106 may each include and/or represent any type or form of optical element, component, and/or feature that spreads and/or expands light. In one example, one or more of light-spreading elements 104 and 106 may include and/or represent a grating, such as a volume Bragg grating (VBG) film. In another example, one or more of light-spreading elements 104 and 106 may include and/or represent a Pancharatnam-Berry phase (PBP) director, layer, and/or lens as implemented in compact beam expander 900 in FIG. 9. In a further example, one or more of light-spreading elements 104 and 106 may include and/or represent an overcoat layer with an undulating and/or rippling surface whose thickness varies along at least one direction as implemented in compact beam expander 1000 in FIG. 10. In an additional example, one or more of light-spreading elements 104 and 106 may include and/or represent an ion-implanted layer with ion-implanted regions whose thicknesses vary along at least one direction as implemented in compact beam expander 1100 in FIG. 11.

In some examples, pixel element 108 may include and/or represent one or more pixels implemented and/or incorporated in an LCOS display. In one example, pixel element 108 may include and/or represent a liquid crystal and/or backplane of an LCOS display. Additionally or alternatively, pixel element 108 may include and/or represent polymer materials, aromatic rings, and/or mesogens that provide and/or exhibit properties of both liquids and solid crystals or between liquids and solid crystals. In certain implementations, pixel element 108 may include and/or represent a pixelated electrode layer that activates a selected portion (e.g., pixel by pixel) of a liquid crystal in reflective mode.

In some examples, pixel element 108 and light-spreading elements 104 and 106 may be configured and/or arranged in various ways relative to one another. For example, light-spreading elements 104 and 106 may be positioned and/or placed proximate to one another in an LCOS display system such that light-spreading element 104 angularly spreads light 102 toward light-spreading element 106. In one example, pixel element 108 may be positioned and/or placed opposite of light-spreading element 104 relative to light-spreading element 106. In this example, pixel element 108 may be positioned and/or placed proximate to (e.g., right next to, flush with, and/or very close to) light-spreading element 106.

In some examples, light 102 may travel and/or traverse from the light source to light-spreading element 104 and then through light-spreading element 106 to pixel element 108. Upon reaching pixel element 108, light 102 may be reflected and/or bounced back through light-spreading element 106 toward a lens and/or a linear polarizer.

As a specific example, a collimated laser may emit light toward a first VBG. In this example, the first VBG may angularly spread the light and then pass the angularly spread light through a second VBG toward a liquid crystal and/or a corresponding backplane. The backplane of the liquid crystal may reflect and/or bounce the light back through the second VGB toward a projection lens and/or an imaging lens that focuses, presents, and/or displays the light for the user's eye. During this second pass through the second VGB, the light may be angularly spread even further before reaching the projection lens and/or imaging lens.

In some examples, apparatus 100 may include and/or represent a compact beam expander of an LCoS display system. In one example, the compact beam expander may include and/or represent one or more VBGs that receives input illumination with one or more visible colors (e.g., red-greed-blue light). In this example, the illumination may include and/or represent a collimated light beam.

In some examples, the compact beam expander may extend and/or run substantially perpendicular and/or orthogonal to the LCoS. In contrast to conventional displays, the LCoS display system may include and/or represent this compact beam expander in place and/or instead of a bulky polarizing beam splitter (PBS) with a layer oriented at an oblique angle relative to both a waveguide and the LCoS.

In some examples, light-spreading element 106 may overlap the LCOS to selectively spread light 102 reflected from the LCOS at selected angles. In one example, the LCoS may include and/or represent a pixelated electrode layer that activates a selected portion (e.g., pixel by pixel) of a liquid crystal layer in reflective mode. In this example, light 102 reflected from a backplane of the LCOS may be spread and/or expanded in controlled way by light-spreading element 106. After that spreading and/or expansion, light 102 may be directed back through the light-spreading element 104 to an optical lens or lens array that focuses light 102 toward a specific target (e.g., the user's pupil). Additionally or alternatively, light 102 may pass from the optical lens and/or lens array through a linear polarizer to clean up and/or improve the image contrast provided to the user.

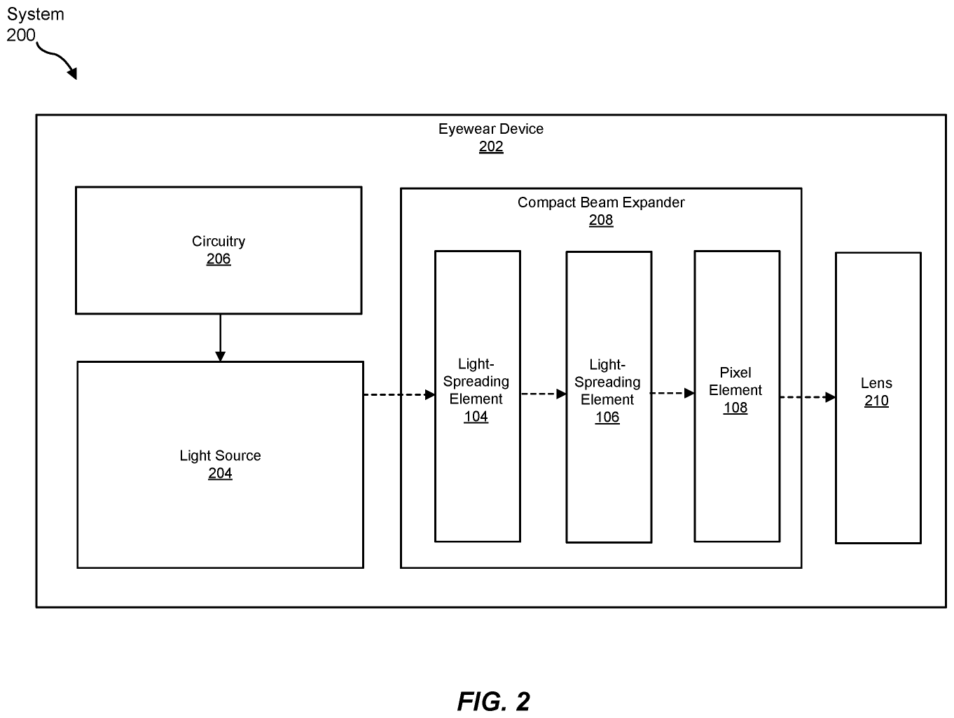

FIG. 2 illustrates an exemplary system 200 capable of spreading light directed toward display in eyewear devices. In some examples, system 200 may include and/or represent certain components, configurations, and/or features that perform and/or provide functionalities that are similar and/or identical to those described above in connection with FIG. 1. As illustrated in FIG. 2, system 200 may include and/or represent an eyewear device 202, a light source 204, circuitry 206, a compact beam expander 208, and/or a lens 210. In one example, compact beam expander 208 may include and/or represent light-spreading element 104, light-spreading element 106, and/or pixel element 108.

In some examples, eyewear device 202 may include and/or represent a head-mounted display (HMD) dimensioned to be worn by a user. In one example, the HMD may include and/or represent any type or form of display device or system that is worn on or about the user's face and displays virtual content, such as computer-generated objects and/or AR content, to the user. HMDs may present and/or display content in any suitable way, including via a display screen, a liquid crystal display (LCD), a light-emitting diode (LED) display, a microLED display, a plasma display, a projector, a cathode ray tube, an optical mixer, combinations or variations of one or more of the same. HMDs may present and/or display content in one or more media formats. For example, HMDs may display video, photos, computer-generated imagery (CGI), and/or variations or combinations of one or more of the same. Additionally or alternatively, HMDs may include and/or incorporate see-through lenses that enable the user to see the user's surroundings in addition to such computer-generated content.

In some examples, HMDs may provide diverse and/or distinctive user experiences. Some HMDs may provide virtual-reality experiences (i.e., they may display computer-generated or pre-recorded content), while other HMDs may provide real-world experiences (i.e., they may display live imagery from the physical world). HMDs may also provide any mixture of live and virtual content. For example, virtual content may be projected onto the physical world (e.g., via optical or video see-through lenses), which may result in AR and/or mixed-reality experiences.

In some examples, circuitry 206 may include and/or represent one or more electrical and/or electronic circuits capable of processing, applying, modifying, transforming, displaying, transmitting, receiving, and/or executing data and/or signals for eyewear device 202. In one example, circuitry 206 may provide data and/or signaling that controls activation and/or deactivation of light source 204 to facilitate and/or support CGI presentation in connection with an AR application.

In some examples, circuitry 206 may launch, perform, and/or execute certain executable files, code snippets, and/or computer-readable instructions to facilitate and/or support spreading light directed toward displays in eyewear devices. Although illustrated as a single unit in FIG. 1, circuitry 206 may include and/or represent a collection of multiple processing units and/or electrical or electronic components that work and/or operate in conjunction with one another. In one example, circuitry 206 may include and/or represent an application-specific integrated circuit (ASIC). In another example, circuitry 206 may include and/or represent a central processing unit (CPU).

Additional examples of circuitry 206 include, without limitation, processing devices, microprocessors, microcontrollers, graphics processing units (GPUs), field-programmable gate arrays (FPGAs), systems on chips (SoCs), parallel accelerated processors, tensor cores, integrated circuits, chiplets, optical modules, receivers, transmitters, transceivers, optical modules, memory devices, transistors, antennas, resistors, capacitors, diodes, inductors, switches, registers, flipflops, digital logic, connections, traces, buses, semiconductor (e.g., silicon) devices and/or structures, storage devices, audio controllers, portions of one or more of the same, variations or combinations of one or more of the same, and/or any other suitable circuitry.

In some examples, circuitry 206 may direct and/or cause light source 204 to emit and/or direct light 102 to compact beam expander 208 to facilitate and/or support spreading and/or expansion. In one example, light 102 may travel and/or traverse to light-spreading element 104. In this example, light-spreading element 104 may diffract, spread, and/or expand light 102 on the way to light-spreading element 106. Additionally or alternatively, light-spreading element 106 may diffract, spread, and/or expand light 102 even further (e.g., in a separate and/or subsequent spreading event). In certain implementations, pixel element 108 may direct and/or point light 102 toward lens 210, which focuses, presents, and/or displays light 102 for the user's eye.

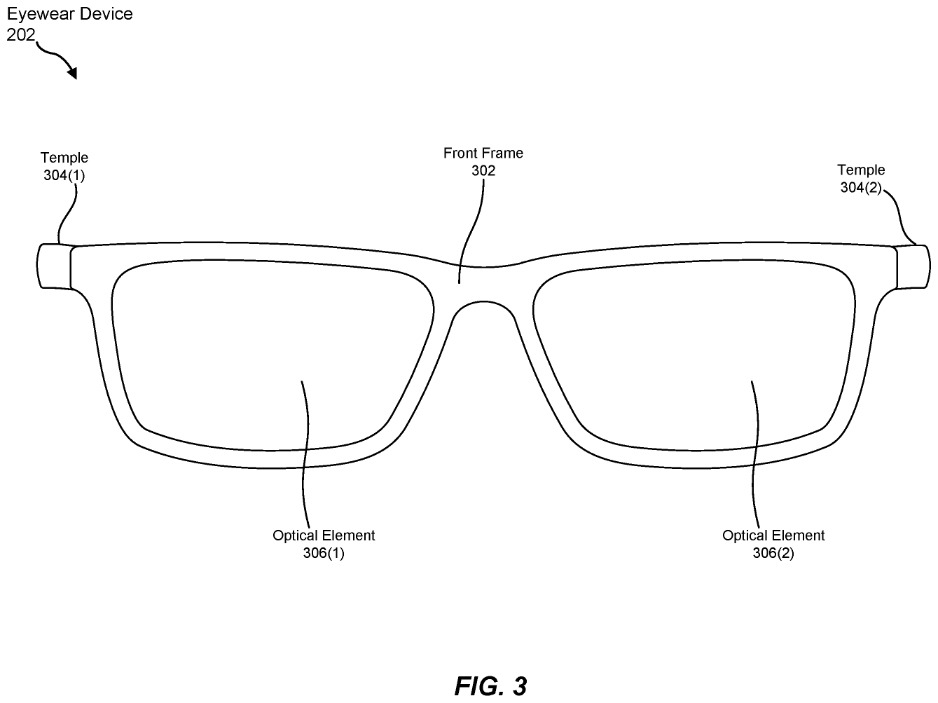

FIG. 3 illustrates an exemplary implementation of eyewear device 202, which facilitates and/or supports spreading light directed towards displays in eyewear devices. In some examples, eyewear device 202 in FIG. 3 may include and/or represent certain components and/or features that perform and/or provide functionalities that are similar and/or identical to those described above in connection with either FIG. 1 or FIG. 2. As illustrated in FIG. 3, eyewear device 202 may include and/or represent an eyewear frame containing one or more components that facilitates, supports, and/or provides light-spreading and/or light-expanding capabilities. In one example, the eyewear frame may include and/or represent a front frame 302, temples 304(1) and 304(2), and/or optical elements 306(1) and 306(2).

In some examples, optical elements 306(1) and 306(2) may be inserted and/or installed in front frame 302. In other words, optical elements 306(1) and 306(2) may be coupled to, incorporated in, and/or held by front frame 302. In one example, optical elements 306(1) and 306(2) may be configured and/or arranged to provide one or more virtual features for presentation to a user wearing eyewear device 202. These virtual features may be driven, influenced, and/or controlled by one or more wireless technologies supported by eyewear device 202. In certain implementations, front frame 302 may include and/or represent a rim of eyewear device 202.

In some examples, one or more of optical elements 306(1) and 306(2) may include and/or represent optical stacks, lenses, and/or films that form and/or constitute a display on which light spread by light-spreading elements 104 and 106. In one example, optical elements 306(1) and 306(2) may each include and/or represent various layers that facilitate and/or support the presentation of virtual features and/or elements that overlay real-world features and/or elements. Additionally or alternatively, optical elements 306(1) and 306(2) may each include and/or represent one or more screens, lenses, and/or fully or partially see-through components. Examples of optical elements 306(1) and 306(2) include, without limitation, electrochromic layers, dimming stacks, transparent conductive layers (such as indium tin oxide films), metal meshes, antennas, transparent resin layers, lenses, films, combinations or variations of one or more of the same, and/or any other suitable optical elements.

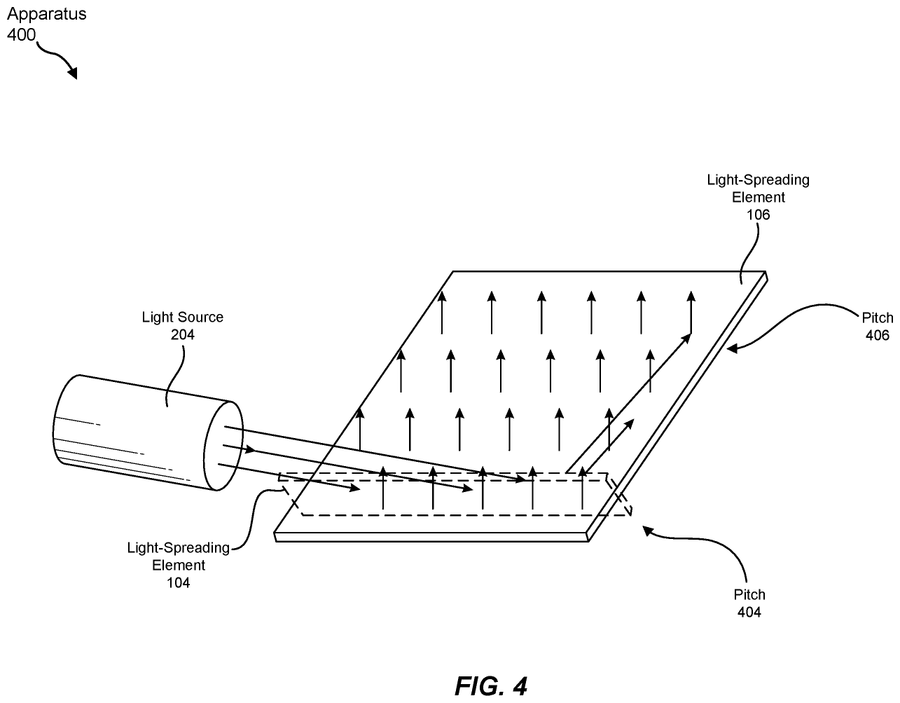

FIG. 4 illustrates an exemplary apparatus 400 capable of spreading and/or expanding light directed toward displays in eyewear devices. In some examples, apparatus 400 in FIG. 4 may include and/or represent certain components and/or features that perform and/or provide functionalities that are similar and/or identical to those described above in connection with any of FIGS. 1-3. As illustrated in FIG. 4, apparatus 400 may include and/or represent a portion of a compact beam expander equipped with light source 204 and light-spreading elements 104 and 106. In some examples, light-spreading element 104 may be configured and/or arranged at a pitch 404 along a certain direction or plane within the compact beam expander. Additionally or alternatively, light-spreading element 106 may be configured and/or arranged at a pitch 406 along the same direction or plane or a different direction or plane within the compact beam expander.

In some examples, pitch 404 may correspond to and/or represent an angle and/or disposition of light-spreading element 104. Additionally or alternatively, pitch 406 may correspond to and/or represent another angle and/or disposition of light-spreading element 106. In one example, pitch 406 may be greater and/or higher than pitch 404. In an alternative embodiment, pitch 404 may be greater and/or higher than pitch 406.

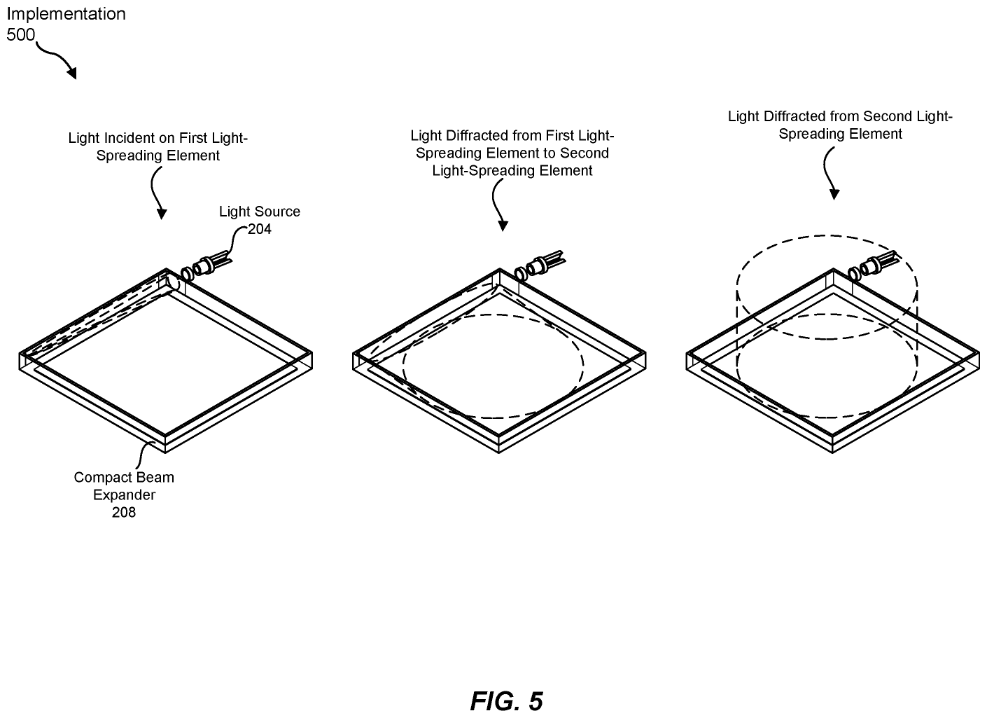

In some examples, the compact beam expander may be configured and/or arranged to receive a collimated gaussian beam (e.g., as provided by a graded index lens placed in front of an LED or laser diode emitter) from light source 204 on light-spreading element 104. Light incident on light-spreading element 104 may be diffracted in a first dimension toward a light-spreading element 106. In one example, light-spreading element 106 may then diffract the light in a second dimension so as to provide a collimated beam with a substantially uniform intensity profile over a cross-section (e.g., a top-hat profile as shown in FIG. 5). In this example, the collimated beam may produce a substantially uniform intensity in the display of an AR eyewear device.

In some examples, apparatus 400 may facilitate, support, and/or provide increased pupil illumination the view of a user wearing the AR eyewear device. In one example, apparatus 400 may improve image contrast from the user's perspective by decreasing, mitigating, and/or eliminating certain impurities (e.g., dust, particles, etc.) capable of affecting optical components included in the display of the AR eyewear device. Additionally or alternatively, apparatus 400 may increase the input aperture in a projection and/or imaging lens in the display of the AR eyewear device. By doing so, apparatus 400 may admit and/or provide a wider angle of incident light for each source point in the display (e.g., a pixel or subpixel) of the AR eyewear device. In certain implementations, the incident light in the viewer's retina may be smeared and/or blurred to a sufficient degree to wash out certain visual artifacts, thereby effectively rendering such visual artifacts less perceptible or even substantially imperceptible to the user.

FIG. 5 illustrates an exemplary implementation 500 of compact beam expander 208. In some examples, implementation 500 in FIG. 5 may include and/or represent certain components and/or features that perform and/or provide functionalities that are similar and/or identical to those described above in connection with any of FIGS. 1-4. As illustrated in FIG. 5, implementation 500 may show and/or demonstrate a first stage and/or phase of beam expansion involving light incident on light-spreading element 104. In one example, implementation 500 may also show and/or demonstrate a second stage and/or phase of beam expansion involving light diffracted and/or spread from light-spreading element 104 toward light-spreading element 106. Additionally or alternatively, implementation 500 may show and/or demonstrate a third stage and/or phase of beam expansion involving light diffracted and/or spread from light-spreading element 106 toward pixel element 108 and/or lens 210.

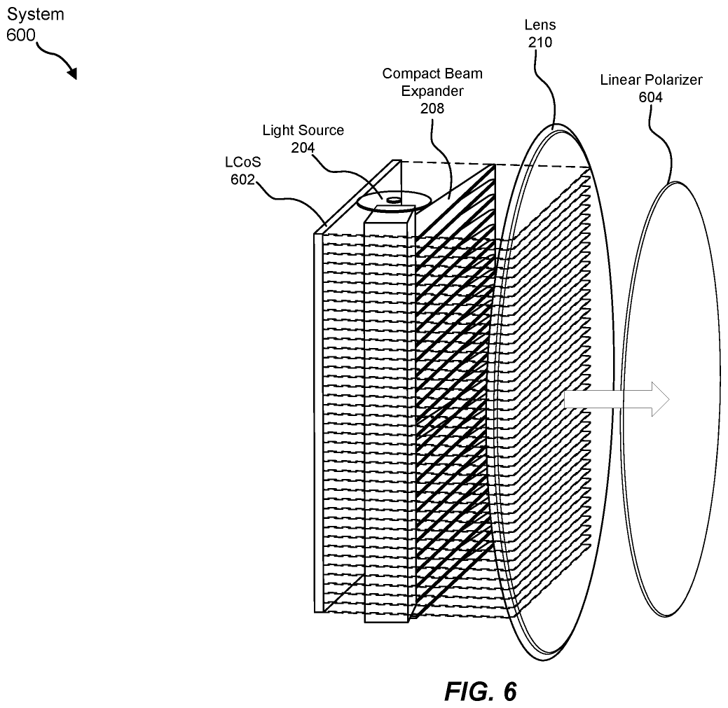

FIG. 6 illustrates an exemplary system 600 capable of spreading light directed toward displays in eyewear devices. In some examples, system 600 in FIG. 6 may include and/or represent certain components and/or features that perform and/or provide functionalities that are similar and/or identical to those described above in connection with any of FIGS. 1-5. As illustrated in FIG. 6, system 600 may include and/or represent an LCoS 602, compact beam expander 208, light source 204, lens 210, and/or a linear polarizer 604. In one example, compact beam expander 208 may reside and/or be positioned between LCOS 602 and lens 210. In this example, lens 210 may reside and/or be positioned between compact beam expander 208 and linear polarizer 604.

In some examples, light source 204 may introduce light into compact beam expander 208, which expands the light via light-spreading element 104. In one example, after expanding the light via light-spreading element 104, compact beam expander 208 may bounce and/or reflect the light off of the backplane of LCOS 602. In this example, upon receiving the light back from the backplane of LCoS 602, compact beam expander 208 may expand the light further via light-spreading element 106. Compact beam expander 208 may then direct, pass, and/or transmit the light through lens 210 and/or linear polarizer 604 toward the eye of a user.

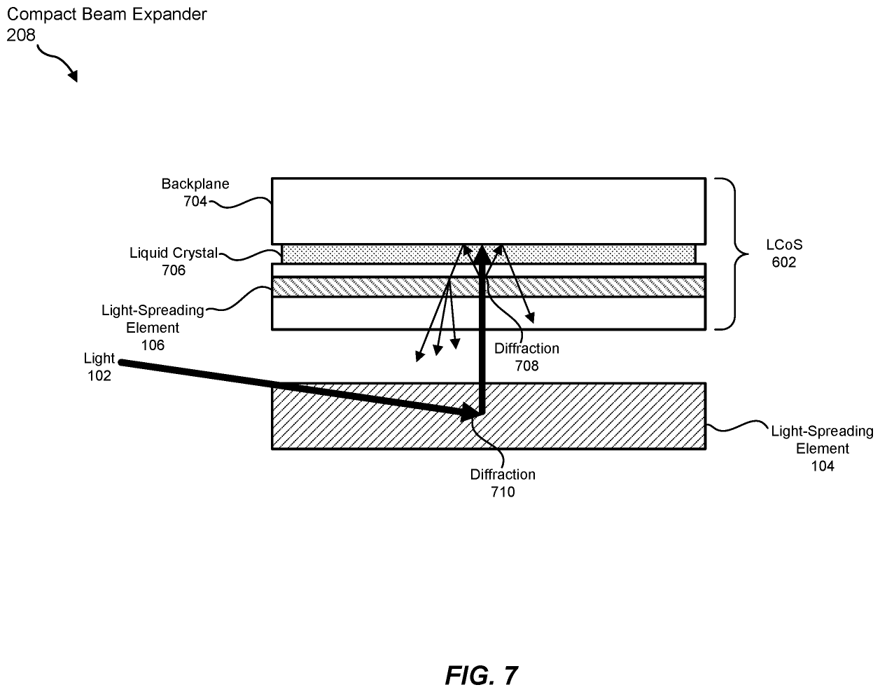

FIG. 7 illustrates an exemplary implementation of compact beam expander 208 capable of spreading light directed toward displays in eyewear devices. In some examples, compact beam expander 208 in FIG. 7 may include and/or represent certain components and/or features that perform and/or provide functionalities that are similar and/or identical to those described above in connection with any of FIGS. 1-6. As illustrated in FIG. 7, compact beam expander 208 may include and/or represent light-spreading elements 104 and 106, a liquid crystal 706, and/or a backplane 704. In one example, LCOS 602 may include and/or represent light-spreading element 106, liquid crystal 706, and/or backplane 704.

In some examples, light 102 may enter compact beam expander 208 via light-spreading element 104, which performs diffraction 710 on light 102 to facilitate and/or support expansion. In one example, light 102 may traverse and/or travel from light-spreading element 104 through light-spreading element 106. In this example, light 102 may then traverse and/or travel through liquid crystal 706 and then reflect and/or bounce off backplane 704 before passing back through liquid crystal 706 and then returning to light-spreading element 106. As light 102 returns, light-spreading element 106 may perform diffraction 708 on light 102 to facilitate and/or support further expansion before light 102 passes through light-spreading element 104 on its way to lens 210.

In some examples, light-spreading element 106 may overlap, intersect, and/or overlay liquid crystal 706. In one example, light-spreading element 106 may have high optical flatness and/or be disposed a relatively small distance from liquid crystal 706 and/or the LCoS backplane (e.g., a distance of approximately 0-10 μm). In certain implementations, light-spreading element 106 may be included within and/or applied to a cover glass assembly disposed on the liquid crystal layer so as to minimize the distance between their constituent components. Additionally or alternatively, light-spreading element 106 may selectively diffract reflected light beams from pixel regions so as to expand the beams within a desired cone angle (e.g., approximately +/−10 to +/−15 degrees for RGB visible light).

In some examples, compact beam expander 208 and/or one or more of its constituent components may implement and/or provide a sinusoidal phase delay over locations along the pitch direction. In one example, light-spreading elements 104 and 106 may include and/or represent an array of diffracting regions having any suitable pitch, such as a pitch of approximately 10-30 μm. In one example, this pitch may be approximately 5-15 times (e.g., 10 times) the pixel width of the pixels in an LCOS display. In certain implementations, the diffracting regions of one or more light-spreading elements 104 and 106 may have a pitch of approximately 20 μm to produce a sinusoidal phase delay with a period of 20 μm in the pitch direction of the corresponding light-spreading element.

In some examples, the relative intensity of one or more of light-spreading elements 104 and 106 may vary at different locations and/or regions. In one example, the variation of such relative intensity may increase commensurate with distance from the liquid crystal layer. Accordingly, the relative intensity distribution may be more uniform when the light-spreading element 106 is disposed and/or positioned in closer proximity to the liquid crystal layer.

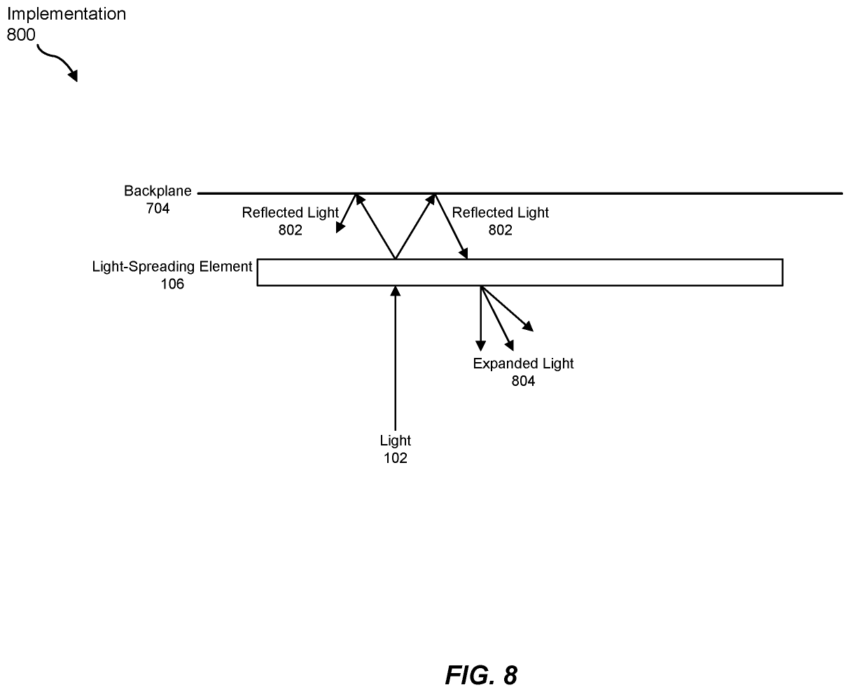

FIG. 8 illustrates an exemplary implementation 800 of light expansion as performed by light-spreading element 106. In some examples, implementation 800 in FIG. 5 may include and/or represent certain components and/or features that perform and/or provide functionalities that are similar and/or identical to those described above in connection with any of FIGS. 1-7. As illustrated in FIG. 8, implementation 800 may show and/or demonstrate two stages of expansion of light 102 as performed by light-spreading element 106. In one example, light-spreading element 106 may diffract, expand, and/or spread light 102 into multiple angles and/or directions. In this example, backplane 704 may reflect and/or light 102 back toward light-spreading element 106 in multiple angles and/or directions, thereby resulting in reflected light 802. In this example, reflected light 802 may pass through light-spreading element 106 again. As reflected light 802 makes this second pass, light-spreading element 106 may diffract, expand, and/or spread reflected light 802, thereby resulting in expanded light 804, which continues toward lens 210.

FIG. 9 illustrates an exemplary compact beam expander 900 capable of spreading light directed toward displays in eyewear devices. In some examples, compact beam expander 900 in FIG. 9 may include and/or represent certain components and/or features that perform and/or provide functionalities that are similar and/or identical to those described above in connection with any of FIGS. 1-8. As illustrated in FIG. 9, exemplary compact beam expander 900 may include and/or represent a PBP director 920, a transparent conductive layer 910 (e.g., an indium tin oxide film), liquid crystal 706, and/or backplane 704.

In some examples, transparent conductive layer 910 may reside and/or be positioned between PBP director 920 and liquid crystal 706. In one example, liquid crystal 706 may reside and/or be positioned between transparent conductive layer 910 and backplane 704. Additionally or alternatively, PBP director 920 may include and/or represent a PBP layer 906, a cover glass 904, and/or quarter wave plates 902 and 908.

In some examples, cover glass 904 may reside and/or be positioned between quarter wave plane 902 and PBP layer 906. In one example, PBP layer 906 may reside and/or be positioned between cover glass 904 and quarter wave plate 908. Additionally or alternatively, quarter wave plate 908 may reside and/or be positioned between PBP layer 906 and transparent conductive layer 910.

In some examples, light 102 may traverse and/or travel through PBP director 920, transparent conductive layer 910, and/or liquid crystal 706 to backplane 704. In one example, light 102 may also traverse and/or travel back from backplane 704 through liquid crystal 706, transparent conductive layer 910, and/or PBP director 920.

In some examples, PBP director 920 may selectively diffracting light 102. In one example, PBP director 920 may include and/or represent a liquid crystal PBP (e.g., a twist structure liquid crystal polymer). Additionally or alternatively, PBP layer 906 may be implemented as a half wave plate characterized by its thickness. In certain implementations, quarter wave plate 908 may directly overlap, intersect, and/or overlay the liquid crystal layer of the LCOS so that PBP layer 906 is disposed and/or positioned in close proximity to the liquid crystal layer (e.g., a distance of less than approximately 10 μm).

In some examples, PBP director 920 may act as a grating that modulates the polarization states or Pancharatnam-Berry phases of light reflected from the LCoS by spatially changing anisotropy parameters across the plane of the liquid crystal layer and/or PBP director 920 on a periodic basis. In one example, diffracting regions of PBP director 920 may have a pitch within a range of approximately 10-30 μm. Additionally or alternatively, the half deviation angle K of PBP director 920 may be oriented perpendicular to the liquid crystal region edges of PBP layer 906. In certain implementations, PBP director 920 may convert circular polarized light to multiple diffracted orders. For example, left circular polarized light may be converted to multiple diffracted orders of right circular polarized light by PBP director 920.

In some examples, PBP director 920 may have one-dimensional orientation and/or coordination states. In one example, the liquid crystals of PBP layer 906 may be configured and/or arranged with orientation states having a pitch of approximately 20 μm in the x-direction. Additionally or alternatively, the liquid crystal orientation of PBP layer 906 may vary sinusoidally according to certain equations, such as φ=90° (1+cos (2πx/pitch)), where φ represents an angular orientation coordinate.

In some examples, PBP director 920 may be two-dimensional orientation and/or coordination states. In one example, the liquid crystal orientation of PBP layer 906 may vary according to certain equations, such as φ=90° (cos (2πx/pitch)+cos (2πy/pitch)) and/or φ=180° (cos (2πx/pitch)+cos (2πy/pitch)), where φ represents an angular orientation coordinate.

FIG. 10 illustrates an exemplary compact beam expander 1000 capable of spreading light directed toward displays in eyewear devices. In some examples, compact beam expander 1000 in FIG. 10 may include and/or represent certain components and/or features that perform and/or provide functionalities that are similar and/or identical to those described above in connection with any of FIGS. 1-9. As illustrated in FIG. 10, exemplary compact beam expander 1000 may include and/or represent an overcoat layer 1002, transparent conductive layer 910 (e.g., an indium tin oxide film), liquid crystal 706, and/or backplane 704.

In some examples, overcoat layer 1002 may include and/or represent a patterned undulating surface 1008 whose thickness varies along at least one direction. In one example, overcoat layer 1002 may include and/or represent an overcoat cover 1006 and/or a cover glass 1004. In this example, overcoat cover 1006 may have and/or provide a first refractive index. Additionally or alternatively, cover glass 1004 may have and/or provide a second refractive index that differs from the first refractive index.

In some examples, transparent conductive layer 910 may reside and/or be positioned between overcoat layer 1002 and liquid crystal 706. In one example, liquid crystal 706 may reside and/or be positioned between transparent conductive layer 910 and backplane 704. In this example, overcoat cover 1006 may reside and/or be positioned between cover glass 1004 and transparent conductive layer 910.

In some examples, light 102 may traverse and/or travel through overcoat layer 1002, transparent conductive layer 910, and/or liquid crystal 706 to backplane 704. In one example, light 102 may also traverse and/or travel back from backplane 704 through liquid crystal 706, transparent conductive layer 910, and/or overcoat layer 1002.

In some examples, undulating surface 1008 may be a nonplanar of overcoat cover 1006. In one example, undulating surface 1008 may be located adjacent to and/or mated against a corresponding nonplanar undulating surface of cover glass 1004. In this example, overcoat layer 1002 may cover the liquid crystal layer of the LCoS. Additionally or alternatively, undulating surface 1008 may follow a predetermined pattern (e.g., a sinusoidal pattern) that varies at a specified pitch (e.g., approximately 10-30 μm) in one or two dimensions over the liquid crystal layer to provide desired amounts of light diffraction at various locations of the LCoS. In certain implementations, overcoat layer 1002 may have a thickness of approximately 2-3 μm.

In some examples, overcoat cover 1006 may be formed of a material (e.g., a polymer) with a different refractive index than cover glass 1004. For example, cover glass 1004 and overcoat cover 1006 may have a refractive index difference of approximately 0.2-0.3. In one example, cover glass 1004 may have a refractive index of 1.75, and overcoat cover 1006 may have a refractive index of 1.5. Due to the difference in refractive index between overcoat cover 1006 and cover glass 1004, undulating surface 1008 may act as a phase grating that diffracts light from various regions of the LCOS at desired angles. In certain implementations, color dispersion through overcoat layer 1002 may have minimal effect on light 102.

In some examples, cover glass 1004 and overcoat cover 1006 may be formed and/or assembled in a variety of ways and/or contexts. In one example, cover glass 1004 may be formed from two planar surfaces. In this example, recesses corresponding to a desired shape of overcoat cover 1006 (e.g., a period grating structure) may be formed in one surface of cover glass 1004 (e.g., by diamond turning). Such recesses may then be filled (e.g., by casting or overcoating) with any suitable material, such as a polymer. In certain implementations, the outer surfaces of overcoat layer 1002 may be planarized in any suitable way (e.g., by diamond turning). Additionally or alternatively, an indium tin oxide layer may then be coated on and/or applied to the exposed planar surface of overcoat layer 1002 (e.g., by a low temperature coating process at approximately 70-80° C.).

FIG. 11 illustrates an exemplary compact beam expander 1100 capable of spreading light directed toward displays in eyewear devices. In some examples, compact beam expander 1100 in FIG. 11 may include and/or represent certain components and/or features that perform and/or provide functionalities that are similar and/or identical to those described above in connection with any of FIGS. 1-10. As illustrated in FIG. 11, exemplary compact beam expander 1100 may include and/or represent an ion-implanted layer 1102, transparent conductive layer 910 (e.g., an indium tin oxide film), liquid crystal 706, and/or backplane 704.

In some examples, ion-implanted layer 1102 may include and/or represent a patterned ion-implanted regions 1106 whose thickness varies along at least one direction. In one example, ion-implanted regions 1106 may have and/or provide varying refractive indices relative to one another. In this example, transparent conductive layer 910 may reside and/or be positioned between ion-implanted regions 1106 and liquid crystal 706. Additionally or alternatively, liquid crystal 706 may reside and/or be positioned between transparent conductive layer 910 and backplane 704.

In some examples, ion-implanted layer 1102 may include and/or represent ion-patterned material (e.g., glass) that covers the liquid crystal layer and/or transparent conductive layer 910 of the LCoS. In one example, ion-implanted regions 1106 may periodically vary in thickness and/or density according to a predetermined pattern (e.g., a sinusoidal pattern). Additionally or alternatively, ion-implanted regions 1106 may vary at a specified pitch (e.g., approximately 10-30 μm) in one or two dimensions over the liquid crystal layer to provide desired amounts of light diffraction at various locations of the LCOS. The ions implanted into ion-implanted layer 1102 may change the refractive index of the material in ion-implanted regions 1106. Due to the differences in the refractive indices of ion-implanted regions 1106 and the ion-free regions, ion-implanted layer 1102 may act as a phase grating that diffracts light from various regions of the LCOS at desired angles.

In some examples, ion-implanted layer 1102 may be formed in a variety of different ways and/or contexts. In one example, the surface of ion-implanted layer 1102 facing liquid crystal 706 and/or transparent conductive layer 910 may first be masked (e.g., with a metal arranged in a certain pattern) with exposed regions. In this example, the masked surface may then be exposed to a suitable ion-containing composition and/or processed at high temperature to selectively implant ions from the ion-containing composition.

In some examples, ions may selectively accumulate in regions covered by metal mask portions. The ion-containing composition may include any suitable ions capable of implanting sufficiently into the glass member. For example, molten AgNO₃ (silver nitrate) salt may be utilized to implant silver ions into the glass member. Additionally or alternatively, compositions including potassium, cesium, and/or other suitable ions may be used for ion-implantation. Larger ionic atoms may provide larger changes in refractive index within ion-implanted layer 1102.

Following ion implantation, the metal mask may be removed from the processed surface of ion-implanted layer 1102. In some examples, the glass member may be kept at a high temperature after ion-implantation to promote further diffusion of ions, resulting in a gray structure rather than a binary structure initially formed during the ion-implantation procedure. The gray structure ion profile may implement, produce, and/or provide a sinusoidal phase pattern suitable for diffracting light from the LCOS in a desired way.

FIG. 12 is a flow diagram of an exemplary method 1200 for spreading light directed toward displays in eyewear devices. In one example, the steps shown in FIG. 12 may be performed during the manufacture and/or assembly of an artificial-reality device. Additionally or alternatively, the steps shown in FIG. 12 may incorporate and/or involve various sub-steps and/or variations consistent with one or more of the descriptions provided above in connection with FIGS. 1-11.

As illustrated in FIG. 12, method 1200 may include and/or involve the step of assembling a compact beam expander by configuring a first light-spreading element to diffract light received from a light source, a second light-spreading element to further diffract the light, and/or a pixel element positioned proximate to the second light-spreading element to direct the light toward a lens that focuses the light (1210). Step 1210 may be performed in a variety of ways, including any of those described above in connection with FIGS. 1-11. For example, an AR equipment manufacturer or subcontractor may assemble a compact beam expander by configuring a first light-spreading element to diffract light received from a light source, a second light-spreading element to further diffract the light, and/or a pixel element positioned proximate to the second light-spreading element to direct the light toward a lens that focuses the light.

In some examples, method 1200 may also include the step of installing the compact beam expander in an eyewear device dimensioned to be worn by a user (1220). Step 1220 may be performed in a variety of ways, including any of those described above in connection with FIGS. 1-11. For example, the AR equipment manufacturer or subcontractor may install the compact beam expander in an eyewear device dimensioned to be worn by a user.

### EXAMPLE EMBODIMENTS

Example 1: A system comprising (1) an eyewear device dimensioned to be worn by a user and (2) a compact beam expander incorporated in the eyewear device, the compact beam expander comprising (A) a first light-spreading element configured to diffract light received from a light source, (B) a second light-spreading element configured to further diffract the light, and (C) a pixel element that is positioned proximate to the second light-spreading element and configured to direct the light toward a lens that focuses the light for an eye of the user.

Example 2: The system of Example 1, wherein the second light-spreading element comprises a Pancharatnam-Berry phase (PBP) director that includes a PBP layer and a pair of quarter wave plates.

Example 3: The system of either Example 1 or Example 2, wherein (1) the PBP layer is positioned between the pair of quarter wave plates, (2) the PBP director further comprises a cover glass positioned between one of the pair of quarter wave plates and the PBP layer, and (3) the compact beam expander further comprises a transparent conductive layer positioned between another one of the pair of quarter wave plates and the pixel element.

Example 4: The system of any of Examples 1-3, wherein the second light-spreading element comprises an overcoat layer having a patterned undulating surface whose thickness varies along at least one direction.

Example 5: The system of any of Examples 1-4, wherein (1) the overcoat layer comprises (A) an overcoat cover having a first refractive index and (B) a cover glass having a second refractive index that differs from the first refractive index, and (2) the compact beam expander further comprises a transparent conductive layer positioned between the overcoat layer and the pixel element.

Example 6: The system of any of Examples 1-5, wherein the second light-spreading element comprises an ion-implanted layer having patterned ion-implanted regions whose thicknesses vary along at least one direction.

Example 7: The system of any of Examples 1-6, wherein the ion-implanted regions have varying refractive indices relative to one another, and the compact beam expander further comprises a transparent conductive layer positioned between the ion-implanted layer and the pixel element.

Example 8: The system of any of Examples 1-7, wherein the pixel element is incorporated in a liquid crystal on silicon (LCOS) display comprising an array of pixels arranged at a specific pitch along one direction, and further comprising a linear polarizer positioned between the compact beam expander and the eye of the user, wherein the linear polarizer is configured to selectively filter the light prior to reaching the eye of the user.

Example 9: The system of any of Examples 1-8, wherein the LCOS display comprises a backplane configured to reflect the light back toward the lens at one or more specific angles.

Example 10: The system of any of Examples 1-9, wherein the first light-spreading element comprises a first diffraction grating configured to angularly spread the light in at least one direction, and the second light-spreading element comprises a second diffraction grating configured to further angularly spread the light in at least one additional direction after the light has been reflected by the backplane.

Example 11: An apparatus comprising (1) a first light-spreading element configured to spread light received from a light source in at least one direction, (2) a second light-spreading element configured to further spread the light in at least one additional direction, and (3) a pixel element that is positioned proximate to the second light-spreading element and configured to direct the light toward a lens that focuses the light for an eye of the user.

Example 12: The apparatus of Example 11, wherein the second light-spreading element comprises a Pancharatnam-Berry phase (PBP) director that includes a PBP layer and a pair of quarter wave plates.

Example 13: The apparatus of either Example 11 or Example 12, wherein (1) the PBP layer is positioned between the pair of quarter wave plates, (2) the PBP director further comprises a cover glass positioned between one of the pair of quarter wave plates and the PBP layer, and (3) the compact beam expander further comprises a transparent conductive layer positioned between another one of the pair of quarter wave plates and the pixel element.

Example 14: The apparatus of any of Examples 11-13, wherein the second light-spreading element comprises an overcoat layer having a patterned undulating surface whose thickness varies along at least one direction.

Example 15: The apparatus of any of Examples 11-14, wherein (1) the overcoat layer comprises (A) an overcoat cover having a first refractive index and (B) a cover glass having a second refractive index that differs from the first refractive index, and (2) the compact beam expander further comprises a transparent conductive layer positioned between the overcoat layer and the pixel element.

Example 16: The apparatus of any of Examples 11-15, wherein the second light-spreading element comprises an ion-implanted layer having patterned ion-implanted regions whose thicknesses vary along at least one direction.

Example 17: The apparatus of any of Examples 11-16, wherein the ion-implanted regions have varying refractive indices relative to one another, and the compact beam expander further comprises a transparent conductive layer positioned between the ion-implanted layer and the pixel element.

Example 18: The apparatus of any of Examples 11-17, wherein the pixel element is incorporated in a liquid crystal on silicon (LCoS) display comprising an array of pixels arranged at a specific pitch along one direction, and further comprising a linear polarizer positioned between the compact beam expander and the eye of the user, wherein the linear polarizer is configured to selectively filter the light prior to reaching the eye of the user.

Example 19: The apparatus of any of Examples 11-18, wherein the LCOS display comprises a backplane configured to reflect the light back toward the lens at one or more specific angles.

Example 20: A method comprising (1) assembling a compact beam expander by configuring (A) a first light-spreading element to diffract light received from a light source, (B) a second light-spreading element to further diffract the light, and (C) a pixel element positioned proximate to the second light-spreading element to direct the light toward a lens that focuses the light, and (2) installing the compact beam expander in an eyewear device dimensioned to be worn by a user.

Embodiments of the present disclosure may include or be implemented in conjunction with various types of artificial-reality systems. Artificial reality is a form of reality that has been adjusted in some manner before presentation to a user, which may include, for example, a VR, an AR, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., AR system 1300 in FIG. 13) or that visually immerses a user in an artificial reality (such as, e.g., VR system 1400 in FIG. 14). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 13, AR system 1300 may include an eyewear device 1302 with a frame 1310 configured to hold a left display device 1315(A) and a right display device 1315(B) in front of a user's eyes. Display devices 1315(A) and 1315(B) may act together or independently to present an image or series of images to a user. While AR system 1300 includes two displays, embodiments of this disclosure may be implemented in AR systems with a single NED or more than two NEDs.

In some embodiments, AR system 1300 may include one or more sensors, such as sensor 1340. Sensor 1340 may generate measurement signals in response to motion of AR system 1300 and may be located on substantially any portion of frame 1310. Sensor 1340 may represent one or more of a variety of different sensing mechanisms, such as a position sensor, an inertial measurement unit (IMU), a depth camera assembly, a structured light emitter and/or detector, or any combination thereof. In some embodiments, AR system 1300 may or may not include sensor 1340 or may include more than one sensor. In embodiments in which sensor 1340 includes an IMU, the IMU may generate calibration data based on measurement signals from sensor 1340. Examples of sensor 1340 may include, without limitation, accelerometers, gyroscopes, magnetometers, other suitable types of sensors that detect motion, sensors used for error correction of the IMU, or some combination thereof.

In some examples, AR system 1300 may also include a microphone array with a plurality of acoustic transducers 1320(A)-1320(J), referred to collectively as acoustic transducers 1320. Acoustic transducers 1320 may represent transducers that detect air pressure variations induced by sound waves. Each acoustic transducer 1320 may be configured to detect sound and convert the detected sound into an electronic format (e.g., an analog or digital format). The microphone array in FIG. 13 may include, for example, ten acoustic transducers: 1320(A) and 1320(B), which may be designed to be placed inside a corresponding ear of the user, acoustic transducers 1320(C), 1320(D), 1320(E), 1320(F), 1320(G), and 1320(H), which may be positioned at various locations on frame 1310, and/or acoustic transducers 1320(I) and 1320(J), which may be positioned on a corresponding neckband 1305.

In some embodiments, one or more of acoustic transducers 1320(A)-(J) may be used as output transducers (e.g., speakers). For example, acoustic transducers 1320(A) and/or 1320(B) may be earbuds or any other suitable type of headphone or speaker.

The configuration of acoustic transducers 1320 of the microphone array may vary. While AR system 1300 is shown in FIG. 13 as having ten acoustic transducers 1320, the number of acoustic transducers 1320 may be greater or less than ten. In some embodiments, using higher numbers of acoustic transducers 1320 may increase the amount of audio information collected and/or the sensitivity and accuracy of the audio information. In contrast, using a lower number of acoustic transducers 1320 may decrease the computing power required by an associated controller 1350 to process the collected audio information. In addition, the position of each acoustic transducer 1320 of the microphone array may vary. For example, the position of an acoustic transducer 1320 may include a defined position on the user, a defined coordinate on frame 1310, an orientation associated with each acoustic transducer 1320, or some combination thereof.

Acoustic transducers 1320(A) and 1320(B) may be positioned on different parts of the user's ear, such as behind the pinna, behind the tragus, and/or within the auricle or fossa. Or, there may be additional acoustic transducers 1320 on or surrounding the ear in addition to acoustic transducers 1320 inside the ear canal. Having an acoustic transducer 1320 positioned next to an ear canal of a user may enable the microphone array to collect information on how sounds arrive at the ear canal. By positioning at least two of acoustic transducers 1320 on either side of a user's head (e.g., as binaural microphones), AR system 1300 may simulate binaural hearing and capture a 3D stereo sound field around about a user's head. In some embodiments, acoustic transducers 1320(A) and 1320(B) may be connected to AR system 1300 via a wired connection 1330, and in other embodiments acoustic transducers 1320(A) and 1320(B) may be connected to AR system 1300 via a wireless connection (e.g., a BLUETOOTH connection). In still other embodiments, acoustic transducers 1320(A) and 1320(B) may not be used at all in conjunction with AR system 1300.

Acoustic transducers 1320 on frame 1310 may be positioned in a variety of different ways, including along the length of the temples, across the bridge, above or below display devices 1315(A) and 1315(B), or some combination thereof. Acoustic transducers 1320 may also be oriented such that the microphone array is able to detect sounds in a wide range of directions surrounding the user wearing the AR system 1300. In some embodiments, an optimization process may be performed during manufacturing of AR system 1300 to determine relative positioning of each acoustic transducer 1320 in the microphone array.

In some examples, AR system 1300 may include or be connected to an external device (e.g., a paired device), such as neckband 1305. Neckband 1305 generally represents any type or form of paired device. Thus, the following discussion of neckband 1305 may also apply to various other paired devices, such as charging cases, smart watches, smart phones, wrist bands, other wearable devices, hand-held controllers, tablet computers, laptop computers, other external compute devices, etc.

As shown, neckband 1305 may be coupled to eyewear device 1302 via one or more connectors. The connectors may be wired or wireless and may include electrical and/or non-electrical (e.g., structural) components. In some cases, eyewear device 1302 and neckband 1305 may operate independently without any wired or wireless connection between them. While FIG. 13 illustrates the components of eyewear device 1302 and neckband 1305 in example locations on eyewear device 1302 and neckband 1305, the components may be located elsewhere and/or distributed differently on eyewear device 1302 and/or neckband 1305. In some embodiments, the components of eyewear device 1302 and neckband 1305 may be located on one or more additional peripheral devices paired with eyewear device 1302, neckband 1305, or some combination thereof.

Pairing external devices, such as neckband 1305, with AR eyewear devices may enable the eyewear devices to achieve the form factor of a pair of glasses while still providing sufficient battery and computation power for expanded capabilities. Some or all of the battery power, computational resources, and/or additional features of AR system 1300 may be provided by a paired device or shared between a paired device and an eyewear device, thus reducing the weight, heat profile, and form factor of the eyewear device overall while still retaining desired functionality. For example, neckband 1305 may allow components that would otherwise be included on an eyewear device to be included in neckband 1305 since users may tolerate a heavier weight load on their shoulders than they would tolerate on their heads. Neckband 1305 may also have a larger surface area over which to diffuse and disperse heat to the ambient environment. Thus, neckband 1305 may allow for greater battery and computation capacity than might otherwise have been possible on a stand-alone eyewear device. Since weight carried in neckband 1305 may be less invasive to a user than weight carried in eyewear device 1302, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1305 may be communicatively coupled with eyewear device 1302 and/or to other devices. These other devices may provide certain functions (e.g., tracking, localizing, depth mapping, processing, storage, etc.) to AR system 1300. In the embodiment of FIG. 13, neckband 1305 may include two acoustic transducers (e.g., 1320(I) and 1320(J)) that are part of the microphone array (or potentially form their own microphone subarray). Neckband 1305 may also include a controller 1325 and a power source 1335.

Acoustic transducers 1320(I) and 1320(J) of neckband 1305 may be configured to detect sound and convert the detected sound into an electronic format (analog or digital). In the embodiment of FIG. 13, acoustic transducers 1320(I) and 1320(J) may be positioned on neckband 1305, thereby increasing the distance between the neckband acoustic transducers 1320(I) and 1320(J) and other acoustic transducers 1320 positioned on eyewear device 1302. In some cases, increasing the distance between acoustic transducers 1320 of the microphone array may improve the accuracy of beamforming performed via the microphone array. For example, if a sound is detected by acoustic transducers 1320(C) and 1320(D) and the distance between acoustic transducers 1320(C) and 1320(D) is greater than, e.g., the distance between acoustic transducers 1320(D) and 1320(E), the determined source location of the detected sound may be more accurate than if the sound had been detected by acoustic transducers 1320(D) and 1320(E).

Controller 1325 of neckband 1305 may process information generated by the sensors on neckband 1305 and/or AR system 1300. For example, controller 1325 may process information from the microphone array that describes sounds detected by the microphone array. For each detected sound, controller 1325 may perform a direction-of-arrival (DOA) estimation to estimate a direction from which the detected sound arrived at the microphone array. As the microphone array detects sounds, controller 1325 may populate an audio data set with the information. In embodiments in which AR system 1300 includes an inertial measurement unit, controller 1325 may compute all inertial and spatial calculations from the IMU located on eyewear device 1302. A connector may convey information between AR system 1300 and neckband 1305 and between AR system 1300 and controller 1325. The information may be in the form of optical data, electrical data, wireless data, or any other transmittable data form. Moving the processing of information generated by AR system 1300 to neckband 1305 may reduce weight and heat in eyewear device 1302, making it more comfortable to the user.

Power source 1335 in neckband 1305 may provide power to eyewear device 1302 and/or to neckband 1305. Power source 1335 may include, without limitation, lithium ion batteries, lithium-polymer batteries, primary lithium batteries, alkaline batteries, or any other form of power storage. In some cases, power source 1335 may be a wired power source. Including power source 1335 on neckband 1305 instead of on eyewear device 1302 may help better distribute the weight and heat generated by power source 1335.

As noted, some artificial-reality systems may, instead of blending an artificial reality with actual reality, substantially replace one or more of a user's sensory perceptions of the real world with a virtual experience. One example of this type of system is a head-worn display system, such as VR system 1400 in FIG. 14, that mostly or completely covers a user's field of view. VR system 1400 may include a front rigid body 1402 and a band 1404 shaped to fit around a user's head. VR system 1400 may also include output audio transducers 1406(A) and 1406(B). Furthermore, while not shown in FIG. 14, front rigid body 1402 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in AR system 1300 and/or VR system 1400 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in AR system 1300 and/or VR system 1400 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, AR system 1300 and/or VR system 1400 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system comprising:
an eyewear device dimensioned to be worn by a user; and
a compact beam expander incorporated in the eyewear device, the compact beam expander comprising:
a first light-spreading element configured to diffract light received from a light source;
a second light-spreading element configured to further diffract the light; and
a pixel element that is positioned proximate to the second light-spreading element and configured to direct the light toward a lens that focuses the light for an eye of the user.

2. The system of claim 1, wherein the second light-spreading element comprises a Pancharatnam-Berry phase (PBP) director that includes a PBP layer and a pair of quarter wave plates.

3. The system of claim 2, wherein:
the PBP layer is positioned between the pair of quarter wave plates;
the PBP director further comprises a cover glass positioned between one of the pair of quarter wave plates and the PBP layer; and
the compact beam expander further comprises a transparent conductive layer positioned between another one of the pair of quarter wave plates and the pixel element.

4. The system of claim 1, wherein the second light-spreading element comprises an overcoat layer having a patterned undulating surface whose thickness varies along at least one direction.

5. The system of claim 4, wherein:
the overcoat layer comprises:
an overcoat cover having a first refractive index; and
a cover glass having a second refractive index that differs from the first refractive index; and
the compact beam expander further comprises a transparent conductive layer positioned between the overcoat layer and the pixel element.

6. The system of claim 1, wherein the second light-spreading element comprises an ion-implanted layer having patterned ion-implanted regions whose thicknesses vary along at least one direction.

7. The system of claim 6, wherein:
the ion-implanted regions have varying refractive indices relative to one another; and
the compact beam expander further comprises a transparent conductive layer positioned between the ion-implanted layer and the pixel element.

8. The system of claim 1, wherein the pixel element is incorporated in a liquid crystal on silicon (LCoS) display comprising an array of pixels arranged at a specific pitch along one direction; and
further comprising a linear polarizer positioned between the compact beam expander and the eye of the user, wherein the linear polarizer is configured to selectively filter the light prior to reaching the eye of the user.

9. The system of claim 8, wherein the LCOS display comprises a backplane configured to reflect the light back toward the lens at one or more specific angles.

10. The system of claim 9, wherein:
the first light-spreading element comprises a first diffraction grating configured to angularly spread the light in at least one direction; and
the second light-spreading element comprises a second diffraction grating configured to further angularly spread the light in at least one additional direction after the light has been reflected by the backplane.

11. The system of claim 8, wherein the second light-spreading element comprises a diffractive array arranged at a different pitch that is greater than the specific pitch and produces a sinusoidal phase delay along at least the one direction.

12. An apparatus comprising:
a first light-spreading element configured to spread light received from a light source in at least one direction;
a second light-spreading element configured to further spread the light in at least one additional direction; and
a pixel element that is positioned proximate to the second light-spreading element and configured to direct the light toward a lens that focuses the light for an eye of a user.

13. The apparatus of claim 12, wherein the second light-spreading element comprises a Pancharatnam-Berry phase (PBP) director that includes a PBP layer and a pair of quarter wave plates.

14. The apparatus of claim 13, wherein:
the PBP layer is positioned between the pair of quarter wave plates;
the PBP director further comprises a cover glass positioned between one of the pair of quarter wave plates and the PBP layer; and
further comprising a transparent conductive layer positioned between another one of the pair of quarter wave plates and the pixel element.

15. The apparatus of claim 12, wherein the second light-spreading element comprises an overcoat layer having a patterned undulating surface whose thickness varies along at least one direction.

16. The apparatus of claim 15, wherein the overcoat layer comprises:
an overcoat cover having a first refractive index; and
a cover glass having a second refractive index that differs from the first refractive index; and
further comprising a transparent conductive layer positioned between the overcoat layer and the pixel element.

17. The apparatus of claim 12, wherein the second light-spreading element comprises an ion-implanted layer having patterned ion-implanted regions whose thicknesses vary along at least one direction.

18. The apparatus of claim 17, wherein the ion-implanted regions have varying refractive indices relative to one another; and
further comprising a transparent conductive layer positioned between the ion-implanted layer and the pixel element.

19. The apparatus of claim 12, wherein the pixel element is incorporated in a liquid crystal on silicon (LCoS) display comprising an array of pixels arranged at a specific pitch along one direction; and
further comprising a linear polarizer positioned between the second light-spreading element and the eye of the user, wherein the linear polarizer is configured to selectively filter the light prior to reaching the eye of the user.

20. A method comprising:
assembling a compact beam expander by configuring:
a first light-spreading element to diffract light received from a light source;
a second light-spreading element to further diffract the light; and
a pixel element positioned proximate to the second light-spreading element to direct the light toward a lens that focuses the light; and
installing the compact beam expander in an eyewear device dimensioned to be worn by a user.
